(19) United States
(12) Patent Application Publication
(10) Pub. No.: US 2009/0046565 A1
(43) Pub. Date: Feb. 19, 2009

(54) METHOD FOR DETERMINING OPTIMUM LASER BEAM POWER AND OTICAL RECORDING MEDIUM

(76) Inventors: Hajime Yuzurihara, Kanagawa (JP); Hiroyuki Iwasa, Kanagawa (JP); Hiroshi Deguchi, Kanagawa (JP)

Correspondence Address: DICKSTEIN SHAPIRO LLP, 1825 EYE STREET NW, Washington, DC, 20006-5403, US

(21) Appl. No.: 12/279,498

(22) PCT Filed: Feb. 15, 2007
(86) PCT No.: PCT/JP2007/053235

§ 371 Date: Aug. 14, 2008

(30) Foreign Application Priority Data
Feb. 20, 2006 (JP) 2006-042953

(51) Int. Cl. G11B 7/00; G11B 7/26

(52) U.S. Cl. 369/116; 369/283; G9B/7; G9B/7.194

(57) ABSTRACT

To provide a method for determining an optimum laser beam power for a single-side, dual-layer optical recording medium having first and second information layers, the method including: determining an optimum laser beam power based on a predetermined characteristic value at the time when the number of overwrite cycles on the recording medium is a predetermined value, wherein the method is conducted by an optical recording/reproduction apparatus utilizing optical change, and wherein the first information layer is closer to the laser irradiation side than is the second information layer.

### TECHNICAL FIELD

The present invention relates to a method for determining an optimum laser beam power, and an optical recording medium.

### BACKGROUND ART

In optical recording media that achieve high-density recording by using a blue-violet laser with a center wavelength of 405 nm and an objective lens with a high numerical aperture (NA) of 0.65 or more, the shortest recording mark length is shorter than those in CDs and DVDs. The shortest recording mark length in such optical recording media generally ranges from as short as 0.15 μm to 0.2 μm, though depending on the recording and modulation schemes.

The shortest recording mark length, when reduced to this level, causes a reduction in the amplitude of signals reproduced by the optical pickup, making it difficult—even using a waveform equalization method similar to that used for DVD—to distinguish signals corresponding to the shortest marks over those corresponding to longer marks for reproduction of information without any errors. The reason for this is that the waveform interference with nearby marks becomes prominent. Reproduction of these signals without any errors requires, for one thing, that marks of desired length be recorded, with spaces of desired length between them.

High-precision recording in phase change optical recording media can be achieved in the following manner: a pulse-shaped laser beam is applied while controlling the laser beam power based on three or more power parameters and controlling the period, start time, and finish time of laser application for each power parameter. Here, there are three basic power parameters used upon laser beam application: recording (peak) power (Pp), erase power (Pe), and bottom power (Pw). Both the number of pulses for each power and the beam application period for Pp and Pb are optimized according to the mark length. For a further precise control of mark length, a four power-based laser application may be employed in which Pb for the head pulse is made different from Pbs for the other pulses. These methods must find an optimum value for each power level, which the value depends on the manner in which the optical disc was manufactured.

If an optimum recording condition differs in each recording medium, different optical recording/reproduction apparatus may adopt different optical recording conditions. In addition, the laser beam power of the apparatus may change due to the attachment of dusts in the apparatus to the objective lens and/or to the end of the lifetime of the laser source itself. Because the recording condition margin narrows in high-density and high-linear velocity recording, it is increasingly becoming essential that an optimum laser beam power be determined by the apparatus. Even when a recording condition is previously recorded in the read-in area of the disc other than user data areas by simply forming therein wobble pits or grooves and by changing their phases, optimum recording cannot necessary be achieved on the disc by simply reading out using the apparatus the recording condition and recording information.

Patent Literatures 1 and 2 each discloses a method of enabling optimum recording regardless of the differences in optimum laser beam power among different recording/reproduction apparatus. These methods determine an optimum recording power based on the characteristic value called “modulation,” which is obtained by recording a random pattern of marks and spaces ranging from the shortest to the longest, subtracting the reflection signal voltage for the crystalline portion of the longest mark from the reflection signal voltage for the amorphous portion thereof, and dividing the value by the reflection signal voltage for the crystalline portion. These methods are used as a method capable of enabling optimum recording even with recording/reproduction apparatus adopting different optimum recording powers.

Meanwhile, rewritable optical recording media are under development in recent years that adopt a format that uses a blue-violet laser beam and objective lens with a numerical aperture of 0.65 for achieving storage capacity of 15 GB in DVD size. As with BD (Blu-ray Disc)-RE (Rewritable), these rewritable media are ones wherein information is recorded in their groove.

Examples of such media with a storage capacity of 15 GB include for instance HD DVD-ROM and HD-DVD; the foregoing rewritable media have as much storage capacity as these media have and, basically, share the same format with HD DVD-R. Moreover, examples of the rewritable media include those having two recording layers at the beam irradiation side for doubling storage capacity to 30 GB. In the present invention, such media are called single-side, dual-layer recording media.

In these recording media, marks ranging in length from 2T (where T is reference clock frequency), the shortest mark, to 11T, the longest mark, are randomly recorded. The 2T mark is about 0.2 μm in length. If information is recorded with this modulation scheme followed by reproduction of signals, among the reflection signals obtainable from the photo diode (PD), the amplitudes of signals corresponding to the 2T marks and mark spaces are smaller than those of signals corresponding to the other longer marks. For this reason, with a waveform equalization method similar to that used for DVD, it results in a situation where signals corresponding to some nearby marks are undesirably reproduced and hence fully discrete signal reproduction cannot be realized. In these rewritable media, therefore, the reproduction method is so designed that this problem can be overcome.

For example, as a special signal processing scheme for increasing recording density and storage capacity to an extent beyond the level achieved by reducing the wavelength of laser beam, an adaptive PRML is employed so as to compensate the amplitude margin reduction that is associated with resolution reduction, whereby stable, high-density reproduction is made possible. PRML, which stands for Partial Responsive Maximum Likelihood, refers to a combination of a waveform equalization technology wherein waveform distortions for reproduced signals that occur during a recording or reproduction process are removed to transform them into waveforms with a shape of interest, and a signal processing technology wherein redundancy of equalized waveforms are actively utilized on the basis of the recording modulation codes and wherein data series that appear to be most appropriate are selected from reproduced signals containing data errors. The modulation method termed ETM (Eight-to-Twelve Modulation) is employed as a recording encoding method.

As a measure of evaluating mark quality, a measure called PRSNR is used rather than jitter which is adopted in CDs and DVDs. PRNSR allows simultaneous expression of the S/N (Signal-to-Ratio) of the reproduced signal and the linearity of an actual waveform and theoretical PR waveform, and which is one of the measures necessary when estimating the bit error rate on a disc. A signal of interest is produced by a special signal processing, and the difference of this signal from the actual reproduced signal is standardized as PRSNR.

When the above-noted reproduction method is required, an optimum laser beam power determined with a conventional method is not satisfactory; it is important to consider asymmetry, i.e., the amount that the center of the amplitude of signal corresponding to the longest mark deviates from that for the shortest mark, a measure indicative of symmetry between the amplitudes of reproduced signals from the shortest and longest marks. Thus, the conventional method that utilizes modulation as a main measure is not enough. Asymmetry varies depending on the number of times that the disc was overwritten, and therefore, it is essential to contemplate a more optimum method.

In addition to the foregoing conventional method, some conventional methods of determining optimum laser beam powers utilize asymmetry as a measure for mark quality evaluation. In this case, there may be some occasions where the value for asymmetry becomes zero—an ideal value—at such a low power that sufficient signal amplitude cannot be obtained, though depending on the recording method adopted. This does not mean that sufficient recording quality cannot be achieved unless the optimum value for asymmetry is zero; rather, the asymmetry value is preferably close to zero. It is difficult in this case to specify a particular asymmetry value as it varies owing to reading errors in the recording/reproduction apparatus.

Furthermore, the conventional methods are directed to single-layer recording media, and have not been applied to single-side, dual-layer recording media before. One of the two information layers of a single-side, dual-layer recording medium—one closer to the beam irradiation side—has different characteristics than the other information layer or an information layer in a single-layer recording medium: it has to admit light so that the other information can receive the light and overwritten by phase change between amorphous and crystalline states by absorption of the light. Ideally, it is necessary for the information layer, which is closer to the beam irradiation side than is the other one, to have a transmittance of 50% or more. In this case, it is necessary in this information layer to reduce the thickness of the recording layer and the reflective, heat dissipation layer which serves to reflect light and help dissipate heat. Accordingly, an optimum recording condition range for this information layer is narrowed to a level that has never been seen in the prior art. To be more specific, the range for an optimum laser beam power is narrowed due to reduced heat dissipation efficiency and absorption efficiency, necessitating the need for a new method for determining an optimum laser beam power performed by the recording/reproduction apparatus, upon recording on a single-side, dual-layer recording medium, especially on the information layer that is closer to the beam irradiation side.

(Patent Literature 1) Japanese Patent (JP-B) No. 3259642

(Patent Literature 2) Japanese Patent (JP-B) No. 3124721

### DISCLOSURE OF THE INVENTION

The present invention has been accomplished in order to overcome the foregoing conventional problems and to provide a method for determining an optimum laser beam power, which the method is capable of recording on optimum recording media at an optimum recording power regardless of the variations in optimum recording power among different recording/reproduction apparatus, and an optical recording medium suitable for the method.

The present invention is based on the findings by the present inventors and means to solve the foregoing problems are described below.

<1> A method for determining an optimum laser beam power for a single-side, dual-layer optical recording medium having first and second information layers, the method including: determining an optimum laser beam power based on a predetermined characteristic value at the time when the number of overwrite cycles on the recording medium is a predetermined value, wherein the method is conducted by an optical recording/reproduction apparatus utilizing optical change, and wherein the first information layer is closer to the laser irradiation side than is the second information layer.

<2> The method for determining an optimum laser beam power according to <1>, wherein a recording power is optimized based on the modulation of the longest mark among marks of various lengths, and an erase power is optimized based on PRSNR while using the optimized recording power as a fixed value.

<3> The method for determining an optimum laser beam power according to one of <1> and <2>, wherein the number of overwrite cycles on the recording medium is 1.

<4> The method for determining an optimum laser beam power according to one of <1> and <2>, wherein the number of overwrite cycles on the recording medium is 10, a value where characteristic values are stabilized.

<5> The method for determining an optimum laser beam power according to any one of <2> to <4>, wherein the optimum erase power is determined at a point where PRSNR is maximized or the rate of PRSNR change with erase power levels off.

<6> The method for determining an optimum laser beam power according to any one of <2> to <5>, wherein the optimum erase power is determined so that asymmetry has a predetermined value.

<7> The method for determining an optimum laser beam power according to any one of <1> to <6>, wherein an optimum laser beam power is determined for the second information layer in a state where the first information layer is recorded after an optimum laser beam power has been determined for the first information layer.

<8> An optical recording medium including: information that is necessary to execute a method for determining an optimum laser beam power according to any one of <1> to <7>.

<9> An optical recording medium including: a recording sensitivity correction factor that allows a method for determining an optimum laser beam power according to <7> to determine an optimum laser beam power for the second information layer in a state where the first information layer has been written.

<10> The optical recording medium according to <8>, wherein the reflectance of each of the first and second information layers corresponding to a user data area is 3% to 6%.

According to the method of the present invention for determining an optimum laser beam power, it is possible to record on optimum recording media at an optimum recording power regardless of the variations in optimum recording power among different recording/reproduction apparatus. In addition, the optical recording medium of the present invention is suitable for the method of the present invention for determining an optimum laser beam power.

### BRIEF DESCRIPTION OF DRAWINGS

FIG. 1 is a schematic diagram of the pulse-generation condition (write strategy) adopted in the present invention.

FIG. 2 is a first graph of recording power vs. modulation and gamma value.

FIG. 3 is a second graph of recording power vs. modulation and gamma value.

FIG. 4 is a cross-sectional view showing the layer configuration of the optical recording medium of the present invention.

FIG. 5 is a block diagram showing the configuration of a recording/reproduction apparatus used in the present invention.

FIG. 6 is a first flowchart of steps in the method of the present invention for determining an optimum laser beam power.

FIG. 7 is a second flowchart of steps in the method of the present invention for determining an optimum laser beam power.

FIG. 8 is a graph of erasure power Pe vs. PRSNR.

FIG. 9 is a plot of PRSNR against the number of overwrite cycles up to 10.

FIG. 10 is a graph of recording power vs. modulation and gamma value in Example 1.

FIG. 11 is a graph of Pe/Ppo vs. PRSNR after 10 overwrite cycles in Example 1.

FIG. 12 is a graph of recording power vs. modulation and gamma value in Example 2.

FIG. 13 is a graph of Pe/Ppo vs. PRSNR after 10 recording cycles in Example 2.

FIG. 14 is a graph of recording power vs. modulation and gamma value in Example 3.

FIG. 15 is a graph of Pe/Ppo vs. PRSNR after 2 recording cycles in Example 3.

FIG. 16 is a graph of recording power vs. PRSNR.

FIG. 17 is a graph of Pe/Ppo vs. asymmetry in Example 4.

FIG. 18 is a graph of recording power vs. modulation in Example 5.

### BEST MODE FOR CARRYING OUT THE INVENTION

The present invention is directed to a technology relating specifically to a rewritable HD DVD on or from which information is recorded or reproduced using a laser beam with a wavelength of 405 nm and an objective lens with an NA of 0.65, and to provide a method for determining an optimum laser beam power for single-side, dual-layer optimum recording media.

The optimum laser beam power as used herein is based on three power parameters: recording power (Pp), erase power (Pe), and bias power (Pb). An additional power parameter (Pp2) is used when controlling the recording power based on 2 or more parameters.

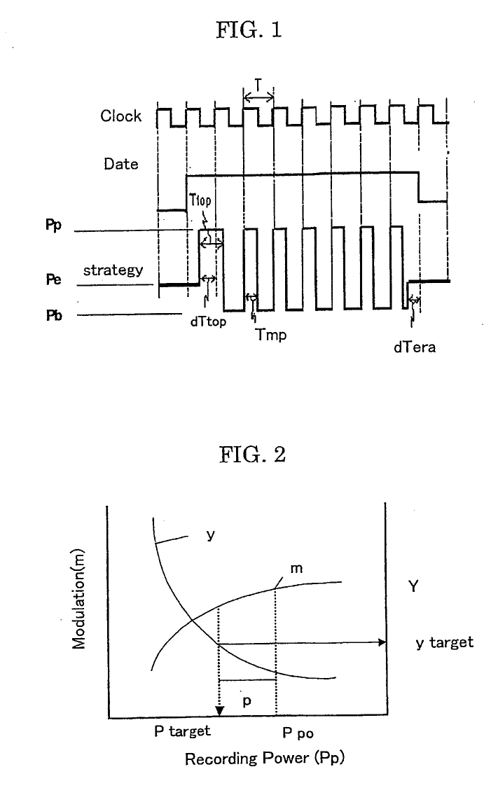

The method for determining an optimum laser beam power basically uses “modulation” as a characteristic value, which is obtained by subtracting the reflection signal voltage for the longest mark from the reflection signal voltage for the mark space, i.e., the amplitude of the reflection signal for the longest mark, and dividing the resultant value by the reflection signal voltage (reflection voltage) for the mark space. In a recording/reproduction apparatus, each parameter is changed in such a way that values for PRSNR, error rate, modulation, and asymmetry fall within predetermined ranges. Note that the apparatus is not specifically restricted to those available in the market; any apparatus capable of evaluation of media characteristics can be used. At this point, the pulse generation condition—hereinafter referred to as “write strategy” (see FIG. 1)—is adjusted in terms of pulse duration, thereby determining an optimum condition previously.

Here, modulation (m) is defined by the following equation:

Modulation=(Reflection Signal Voltage for 11T Mark)−(Reflection Signal Voltage for 11T Mark Space)/(Reflection Signal Voltage for 11T Mark)

Upon determination of an optical laser beam power, information is recorded at various recording powers (Pp) with a write strategy, Pe/Pp, and bias power Pb, which have been previously determined. The recording area reserved for determining the optimum laser beam power is a test write area placed radially inward side of the disc, rather than user data areas preserved for user.

In this trial, measurements for modulation (m) are made at various recording powers (Pp), ranging from the lowest to the highest within which the recording/reproduction apparatus can perform recording/reproduction, and the measurement results are stored in the data processing LSI. The modulation (m) is dependent on the recording power (Pp) as shown in FIG. 2. Here, the values for the erasure power (Pe) and bias power (Pb) are determined using predetermined values for Pe/Pp and Pb/Pp. In the conventional method, the gamma value (γ) is calculated: (γ)=(dm/dPp)×(Pp/m). The target gamma (γtarget) is then set using this equation.

The target gamma (γtarget) is not selected from areas where modulation (m) reached a plateau and where the rate of modulation increase is large, i.e., areas where the recording power is significantly low. Before the modulation (m) reaches the plateau, it is preferable to select a γtarget value from areas corresponding to the modulation (m) values ranging from about 0.4 to 0.5 provided that modulation levels off at 0.6 to 0.65. Thus, even when the absolute value for the recording power differs among recording apparatus, nearly the same γtarget value can be obtained because the dependency of the modulation curve on the recording power is preserved.

A value given by multiplying Ptarget, a recording power corresponding to γtarget, by factor (ρ) is the optimum recording power (Ppo). The factor (ρ) is selected so that best characteristic values can be obtained. This allows selection of an optimum recording power—a recording power capable of obtaining optimum recording characteristic values—even when it differs among different recording apparatus.

Conventionally, this method has been applied to single-side, single-layer recording media, but as envisioned in single-side, dual-layer recording media, a reduction in optimum characteristic value range means a reduction in the optimum recording condition range; therefore, some characteristic values do not necessarily take an optimum value if an optimum recording power is selected based only on modulation.

Some rewritable recording media undergo substantial characteristic value changes after each overwrite cycle. The current situation requires high recording speed—4×, 8×, or 12× the reference linear velocity (1×), and phase change optical recording media, even those with a single-side, single-layer configuration, tend to offer a significant reduction in characteristics values after first overwrite cycle (i.e., after 2 recording cycles) compared to after first recording cycle (i.e., first recording on non-recorded areas) and after 10 overwrite cycles. However, there may be a case where an optimum recording power is not necessarily obtained—even though the next overwrite is taken into consideration—depending on what cycle the parameters were adopted. In general, an optimum recording power is determined after 10 recording cycles.

In addition to the method for determining an optimum recording power using the foregoing characteristic value called modulation, there is a method that adopts asymmetry. Herein, “asymmetry” is defined as follows:

Asymmetry=(I11H+I11L−I2H−I2L)/(2(I11H−I12L))

It is desirable that the asymmetry value equal to zero. Even when it succeeded in obtaining high modulation values, an asymmetry value greatly deviated from zero leads to an increase in errors depending on the recording power condition. Thus, it is not desirable to optimize the recording power based only on this characteristic value. It may be that asymmetry gets close to zero even with insufficient modulation, depending on the recoding condition. In particular, write strategy and erase power are more dependent on asymmetry. When considering the characteristic value called PRSNR, it is difficult to determine an optimum recording power based merely on modulation or asymmetry like in conventional occasions. However, modulation is an essential characteristic value.

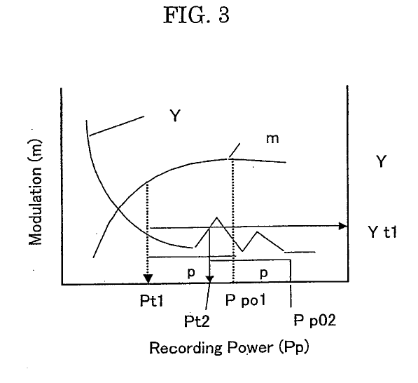

PRSNR increases with increasing amplitude of the signals for longest marks, and it is preferable to make as much difference in signal amplitude as possible among different marks. The recording power (Pp) is determined using modulation. Moreover, what it needs to be careful when determining modulation based on “γ” is how to select the value for “dPp” in the equation (γ)=(dm/dPp)×(Pp/m). When “dPp” is allowed to have a value of 0.1 mW, in the recording power area where the modulation curve begins to level off, the (γ) value fluctuates, failing to draw such a curve as shown in the graph of FIG. 2 (see FIG. 3).

In the case of curves as shown in FIG. 3, it results in the production of two different Ptarget values—Pt1 and Pt2—if the recording apparatus selects γt1 shown in the drawing, which is previously stored in the recording medium. In this case, selection of Pt2 as the Ptarget value results in the selection of Ppo2, a higher optical recording power than Ppo1. If the recording power is too high, the characteristic values decreases, resulting in the selection of a recording power which is not optimum. Moreover, even when the characteristic values still fall within their optimum ranges, they may further decrease after 100 overwrite cycles, 1,000 overwrite cycles, and so forth.

In this case, it is possible to decrease fluctuations in γ value by adopting a large dPp value (e.g., 0.5 mW or more) or by approximating the modulation curve by quadratic function to minimize variations in the modulation values. It is preferable to employ a polynomial approximation technique using for example the following formula, so that the obtained curve is identical to the original modulation curve as much as possible:

K, n*Pw+k, n*Pŵ2+k, n*PŴ3+k, . . . n*Pŵn+a0

where “n” is 2 or more, and “k” and “n” are factors.

When an optimum recording power that has been determined properly is found to exceed a maximum power obtainable by a recording apparatus, it is only necessary to allow the apparatus to perform recording at that maximum power. The method for determining optimum laser beam power will be described in detail in Examples.

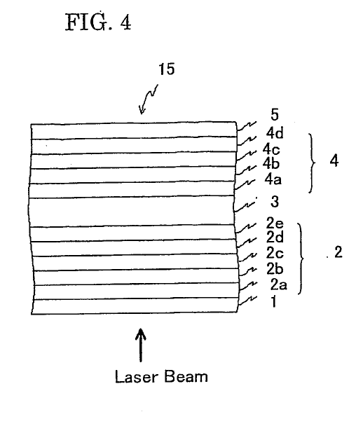

FIG. 4 shows an example of a rewritable single-side, dual-layer optical recording medium. A single-side, dual-layer optical recording medium 15 includes, from the laser beam irradiation side, a first substrate 1, a first information layer 2, an intermediate layer 3, a second information layer 4, and a second substrate 5. The first information layer 2 includes, from the side closer to the first substrate 1, a first lower protective layer 2a, a first recording layer 2b, a first upper protective layer 2c, a first reflective layer 2d, and a thermal diffusion layer 2e. The second information layer 4 includes, from the side closer to the intermediate layer 3, a second lower protective layer 4a, a second recording layer 4b, a second upper protective layer 4c, and a reflective layer 4d.

Materials used to prepare the first recording layer 2b are eutectic compositions of Sb (antimony) and Te (tellurium), in which the content of Sb is about 70% More specific examples include Ag—In—Ge—Sn—Te. Other materials may be used for higher recording velocities; examples are Ge—In—Sb alloys added with an additional element such as Zn, and Ge—Sn—Sb alloys added with an additional element such as Zn.

The first recording layer 2b preferably ranges from 5 nm to 9 nm in thickness; a first recording layer thickness of less than 5 nm results in high light transmittance, reduction in recording sensitivity, low layer temperature which is insufficient for the recording layer to melt to make repetitive recording possible, low rapid cooling rate, and poor initial characteristics as well as poor repetitive recording characteristics, whereas a first recording layer thickness of greater than 9 nm results in too low light transmittance of the first information layer, thereby reducing the sensitivity of the second information layer 4 to a greater extent. The second recording layer 4b preferably ranges from 10 nm to 20 nm in thickness.

The first reflective layer 2d preferably ranges from 7 nm to 12 nm in thickness, a first reflective layer thickness of less than 7 nm causes reduction in reflectance and modulation, whereas a first reflective layer thickness of greater than 12 nm results in too low light transmittance of the first information layer 2, reducing the recording sensitivity of the second information layer to a greater extent. Note that Ag is used for the first reflective layer 2d, and the addition of at least one metal element selected from Bi, Cu, In, etc., in an amount of 0.2% to 5.0% by mass can improve reproduction stability and reliability of the first information layer. Preferably, the second reflective layer 4d is made of Ag alloy rather than Ag, and ranges from 100 nm to 200 nm in thickness.

Preferably, the upper protective layers 2c and 4c provided adjacent to the information layers are made of material which is capable of increasing the environmental durability of their recording layers, is transparent, and has a higher melting point than the recording layers. In single-side, single-layer phase change optical recording media, ZnS—SiO₂ is often used. In that case, it is acknowledged that the best ratio of ZnS to SiO₂ (ZnS:SiO₂) is 80:20. The single-side, dual-layer phase change optical recording media, however, has a first reflective layer 2d that is thinner than that of the single-side, single-layer optical recording media. For this reason, the heat dissipation capability is reduced and thus creation of amorphous phase becomes difficult. Thus it is preferable to use materials with as high thermal conductivity as possible for the first upper protective layer 2c. It is thus preferable to use oxides with higher heat dissipation capability than ZnS—SiO₂. Specific suitable examples are metal oxides such as ZnO, SnO₂, Al₂O₃, TiO₂, In₂O₃, MgO, ZrO₂, TaO, Ta₂O₅, and Nb₂O₅. Note that when Zn—SiO₂ is used for the upper protective layer 2c and Ag is used for the reflective layer 2d, it is necessary to provide a sulfuration prevention layer so as to prevent Ag in the reflective layer from reacting with S in the upper protective layer. For example, a mixture of TiO₂ and TiC can be used for this layer. The first upper protective layer 2c preferably ranges from 10 nm to 35 nm in thickness. The second upper protective layer 4c is made of ZnS—SiO₂ as is conventional. When Ag or Ag alloy is used for the second reflective layer 4d, an interface layer which ranges from 2 nm to 4 nm in thickness and made of, for example, TiOC is provided between the second upper protective layer 4c and the second reflective layer 4d. The best ratio of ZnS to SiO₂ (ZnS:SiO₂) in each of the lower protective layers 2a and 4a is 80:20.

It is desirable for the thermal diffusion layer 2e to have high thermal conductivity for rapid cooling of the first recording layer 2b that has been irradiated with laser beam light. Moreover, it is desirable for the thermal diffusion layer 2e to absorb less light over a wavelength of laser beam to be applied, that is, the thermal diffusion layer 2e desirably admits the laser beam and have a refraction index of as high as 2 or more, so that recording and reproduction of information can be made possible. For example, InZnOₓ or InSnOₓ are preferable. In addition, the content of the tin oxide present in InSnOₓ preferably ranges from 1% to 10% by mass. If the tin oxide content falls outside this range, it causes reduction in thermal conductivity and transmittance. The content of In₂O₃ present in InZnOₓ or InSnOₓ is preferably about 90 mol %. The thermal diffusion layer 2e preferably ranges from 10 nm to 40 nm. In addition, Nb₂O₅, ZrO₂, and TiO₂ are also preferable materials.

It is necessary for the first substrate 1 to sufficiently admit laser beam light applied for recording and reproduction of information, and materials known in the art are adopted for it. That is, glass, ceramics, resin, etc., are used. In particular, resin is suitable in view of moldability and costs; examples include polycarbonate resins, acrylic resins, epoxy resins, polystyrene resins, acrylonitrile-styrene copolymer resins, polyethylene resins, polypropylene resins, silicon resins, fluorine resins, ABS resins, and urethane resins. However, polycarbonate resins and acrylic resins such as polymethacrylate (PMMA) are preferable in view of their excellent moldability, optical characteristics, and costs. On the surface of the first substrate 1 on which the first information layer 2 is to be deposited, there is a pattern of concaves and convexes, such as spiral or concentric grooves. This pattern is generally formed by, for instance, injection molding or photopolymerization. The first substrate 1 preferably ranges from 590 μm to 610 μm in thickness, and the second substrate 5 is made of the same material as the first substrate 1.

Desirably, the intermediate layer 3 absorbs less light over a wavelength of laser beam to be applied for recording and reproduction of information, and is made of resin in view of moldability and costs; for example, UV curable resins, slow curing resins, and thermoplastic resins can be used. The second substrate and intermediate layer 3 may have a pattern of concaves and convexes such as grooves formed by injection molding or photopolymerization, as does the first substrate 1. The intermediate layer 3 serves to distinguish the first information layer 2 from the second information layers 4 for optical separation during the recording or reproduction of information, and preferably ranges from 10 μm to 70 μm in thickness. An intermediate layer thickness of less than 10 μm results in a situation where crosstalk becomes more likely to occur between the information layers, whereas an intermediate layer thickness of greater than 70 μm results in spherical aberration while information is recorded on or reproduced from the second recording layer 4b, thereby making recording and reproduction operations difficult to perform.

The reflectance of each of the information layers 2 and 4 in the single-side, dual-layer optical recording medium ranges from 3.5% to 8%. If the reflectance is less than 3.5%, there is a possibility that the recording/reproduction apparatus fails to achieve laser focusing and groove tracking. Although there is no upper limit with respect to reflectance, approximately 8% is the practical limit, and the lower limit is preferably 4% or more. While it is easy to raise the reflectance of one of the information layers 2 and 4, if the reflectance of the other layer is too low, the difference in reflectance between the information layers 2 and 4 becomes large. For this reason, when switching the information layer from one to the other, it may be difficult to cause the laser beam to focus on the other information layer. Thus, the reflectance of one of the information layers is preferably 1.5 times or less that of the other.

In this embodiment, at least one of a read-in area of an optical recording medium—an area closer to the center of the disc than is the user data area—and a read-out area—an area around the periphery of the disc—is pre-formatted with information concerning the recording condition used in recording processing to be described later, that is information concerning set values used to determine an optimum recording power and an optimum erase power. The phrase “pre-formatted” means that pits are previously formed on the disc, as in ROMs.

A manufacturing method for optical recording media will be briefly described below. The manufacturing method comprises a film deposition step, an initialization step and a bonding step, which are normally performed in this order. In the film deposition step, a first lower protective layer 2a, a first recording layer 2b, a first upper protective layer 2c, a first reflective layer 2d, and a thermal diffusion layer 2e are sequentially deposited onto a surface of a first substrate 1 on which a pattern of concaves and convexes is formed. The article manufactured above, which is formed of a first information layer 2 deposited on the first substrate 1, will be referred to as “first recording member” for the sake of convenience.

Furthermore, a second reflective layer 4d, a second upper protective layer 4c, a second recording layer 4b, and a second lower protective layer 4a are sequentially deposited on a surface of a second substrate 5 on which a pattern of concaves and convexes is formed. The article manufactured above, which is formed of a second information layer 4 deposited on the second substrate 5, will be referred to as “second recording member” for the sake of convenience.

Each layer described above is deposited by sputtering. In the following initialization step, the first and second recording members are irradiated with a laser beam for initialization or crystallization of their entire surface. In this initialization step, the recording members may be separately initialized before bonded together; or the second recording member may be first initialized, followed by its bonding to the first recording member and initialization of the first recording member.

In the bonding step, where the first and second recording members are bonded together, they are bonded together with an intermediate layer 3 that is interposed between them. For example, after coating one of the thermal diffusion layer 2e and second lower protective layer 4a with UV-curable resin, the first and second recording members are bonded together, with the thermal diffusion layer 2e and second lower protective layer 4a facing each other, and then the UV-curable resin is cured by irradiation with UV. In this way, the first and second recording members are combined together by the intermediate layer 3, forming a single-side, dual-layer optical recording medium.

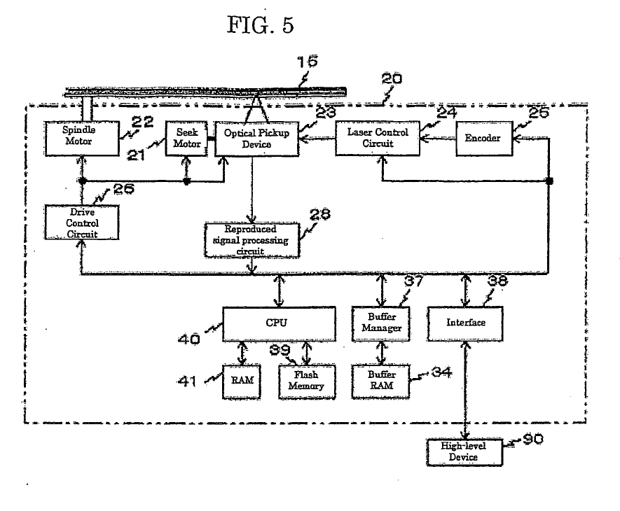

An example of an optical recording/reproduction apparatus 20 is shown in FIG. 5.

The optical recording/reproduction apparatus 20 includes for instance a spindle motor 22 for rotating an optical disc 15 which is a single-side, dual-layer optical recording medium according to one embodiment of the present invention, an optical pickup device 23, a seek motor 21 for driving the optical pickup device 23 to move to the sledge direction, a laser control circuit 24, an encoder 25, a drive control circuit 26, a reproduced signal processing circuit 28, a buffer RAM 34, a buffer manager 37, an interface 38, a flash memory 39, a CPU 40, and a RAM 41. Note in FIG. 5 that arrows indicate flow of representative signals and information, not all connections between blocks. Note also in this embodiment that the optical disc apparatus 20 is supposed to be capable of recording on single-side, multi-layer optical discs.

The reproduced signal processing circuit 28 acquires for instance servo signals (e.g., focus error signals and track error signals), address information, synchronization information, RF signals, modulation information, gamma value information, asymmetry information, and amplitude information of sum signals, based on the output signals (multiple photoelectric conversion signals) from the photo-receiver, or photo diode (PD).

The servo signals thus obtained are then output to the drive control circuit 26, the address information to the CPU 40, and the synchronized signals to the encoder 25, drive control circuit 26 and the like. The reproduced signal processing circuit 28 performs decoding and error detection operations to the RF signals. If any error has been detected, error correction processing is performed, and the RF signals are stored as reproduced data in the buffer RAM 34 via the buffer manager 37. The address information stored in the reproduced data is output to the CPU 40. The reproduced signal processing circuit 28 sends the modulation information, gamma value information, asymmetry information, amplitude information of sum signals, and PRSNR value to the CPU 40.

The drive control circuit 26 generates drive signals for driving the foregoing drive units based on the servo signals received from the reproduced signal processing circuit 28, and outputs them to the optical pickup device 23. Thereby, tracking control and focusing control are performed. The drive control circuit 26 generates a drive signal for driving the seek motor 21 and a drive signal for driving the spindle motor 22 as instructed by the CPU 40. The drive signals are output to the corresponding motors—the seek motor 21 and spindle motor 22.

The buffer RAM 34 temporarily stores, for example, data to be recorded in the optical disc 15 (recording data) and data reproduced from the optical disc 15 (reproduced data). Input or output of data to or from the buffer RAM 34 is managed by the buffer manager 37.

As instructed by the CPU 40, the encoder 25 retrieves recording data stored in the buffer RAM 34 via the buffer manager 37, modulates the data, and adds error correction codes to the data, generating a write signal for writing the optical disc 15. The write signal thus generated is output to the laser control circuit 24.

The laser control unit 24 controls laser output power of the semiconductor laser LD. For example, upon recording, a drive signal for driving the semiconductor laser LD is generated by the laser control circuit 24 on the basis of the write signal, recording condition, emission characteristics of the semiconductor laser LD.

The interface 38 is an interface for bilateral communication with a high-level device 90 (e.g., personal computer), and is compliant with the standard interfaces such as ATAPI (At Attachment Packet Interface), SCSI (Small Computer System Interface), and USB (Universal Serial Bus).

The flash memory 39 stores therein various types of programs written in codes decodable by the CPU 40 such as programs for determining optimum power, emission characteristics of the semiconductor laser LD, etc.

The CPU 40 controls the operations of the foregoing units in accordance with the programs stored in the flash memory 39, and stores in the RAM 41 and buffer RAM 34 data and the like that are necessary for operation control.

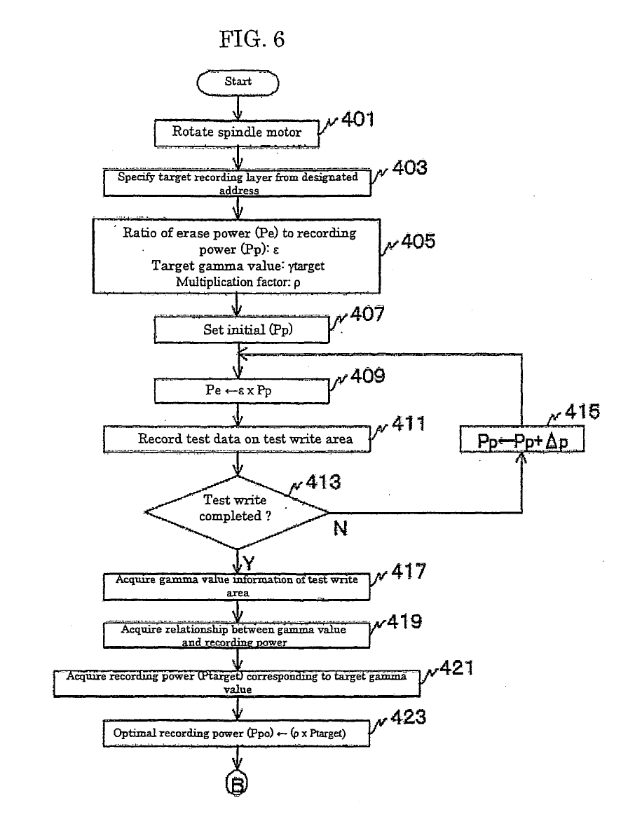

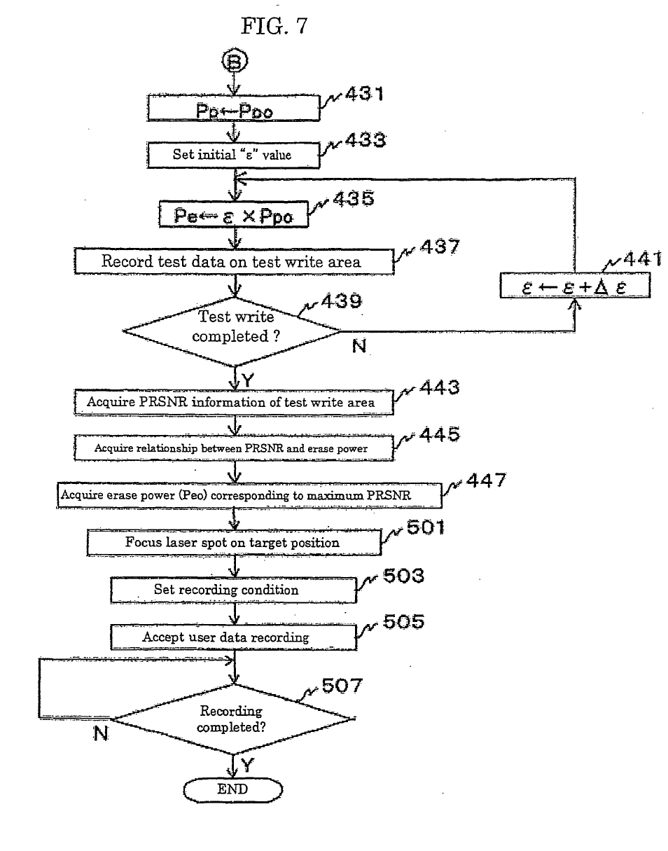

The process (recording process) executed in the optical disc device 20 upon receipt of a command from the high-level device 90 will be described with reference to FIGS. 6 and 7. The flowcharts shown in these drawings correspond to a series of process algorithms executed by the CPU 40.

Upon receipt of a recording request command from the high-level device 90, the head address of a program in the flash memory 39, which corresponds to the flowcharts of FIGS. 6 and 7, is set in the program counter of the CPU 40, and then a recording process starts.

In the initial step (Step 401), the drive control circuit 26 is instructed to rotate the optical disc 15 at a predetermined linear velocity (or angular velocity), and the reproduced signal processing circuit 28 is notified to the effect that the command has been received from the high-level device 90.

In the next step (Step 403), the designated address is retrieved from the recording request command, and it is determined from the address whether the target recording layer is the first recording layer 2b or the second recording layer 4b.

In the next step (Step 405), information is retrieved from the pits of the optical disc 15 which store information concerning recording conditions, thereby calculating “ε,” which is the ratio of erase power (Pe) to recording power (Pp) (=Pe/Pp), γtarget, and “ρ,” which is a multiplication factor for calculating an optimum recording power. The obtained values are stored in the RAM 41.

In the next step (Step 407), an initial value for recording power (Pp) is set and sent to the laser control circuit 24.

In the next step (Step 409), erase power (Pe) is calculated in such a way that the ratio of erase power (Pe) to recording power (Pp) equals to “ε” and sent to the laser control circuit 24.

In the Next step (Step 411), the CPU 40 instructs the laser control circuit 24 and optical pickup device 23 to record test data in the test write area previously provided in the target recording layer. Note in this case that although various marks ranging in length from 2T to 11T are randomly recorded, the frequency of their occurrence is previously determined. Thus the test data is recorded in the test write area by the laser control circuit 24 and the optical pickup device 23. Prior to test write, the test write area may be thoroughly irradiated with a laser beam at Pe for once. This may be performed regardless of the presence of marks, because in some optical discs, crystalline areas (non-recorded areas) produce different reflection signal voltages, i.e., voltage sometimes greatly fluctuates in some of these areas and thus precise signal reproduction is impossible. It is necessary to set the number of test write cycles; here, the test write area is overwritten 10 times.

In the next step (Step 413), it is determined whether test write has been completed or not. If it is determined that test write has not been completed, the determination is rejected and process proceeds to Step 415.

In Step 415, a variation Δp, a value which is previously set, is added to recording power (Pp), and process goes back to Step 409.

Until the determination in Step 413 is accepted, the cycle of Step 409, Step 411, Step 413, and Step 415 are repeated. Once test write has been completed at different recording powers (Pp) which are previously set, the determination made in Step 413 is accepted and process proceeds to Step 417. In Step 417, the test data-recorded test write area is read by the reproduced signal processing circuit 28 for acquisition of the modulation information, and at the same time, an gamma value is calculated.

In the next step (Step 419), as shown in FIG. 2 by way of example, the relationship between recording power (Pp) and modulation (m) and gamma value is established using the modulation information.

In the next step (Step 421), the recording power (Ptarget) is calculated using γtarget—a target gamma value—from the graph of recording power (Pp) vs. gamma value and the graph of recording power (Pp) vs. modulation (m).

In the next step (Step 423), an optimum value for recording power (defined as “Ppo”) is calculated using the equation Ppo=ρ×Ptarget.

In the next step (Step 431), recording power is set to Pro, an optimum value, and sent to the laser control circuit 24.

In the next step (Step 433), an initial value for “ε” is set.

In the next step (Step 435), the value of (ε×Pro) is calculated and sent to the laser control circuit 24 as erase power (Pe).

In the next step (Step 437), the CPU 40 instructs to record test data in the test write area previously provided in the target recording layer. The test data is recorded in the test write area by the laser control circuit 24 and the optical pickup device 23.

In the next step (Step 439), it is determined whether test write has been completed or not. If it is determined that test write has not been completed, the determination is rejected and process proceeds to Step 441.

In Step 441, a variation Δε, a value which is previously set, is added to “ε,” and process goes back to Step 435.

Until the determination in Step 439 is accepted, the cycle of Step 435, Step 437, Step 439, and Step 441 are repeated. Once test write has been completed at different ε values which are previously set, the determination made in Step 439 is accepted and process proceeds to Step 443.

In Step 443, the test data-recorded test write area is read by the reproduced signal processing circuit 28 for acquisition of the PRSNR information.

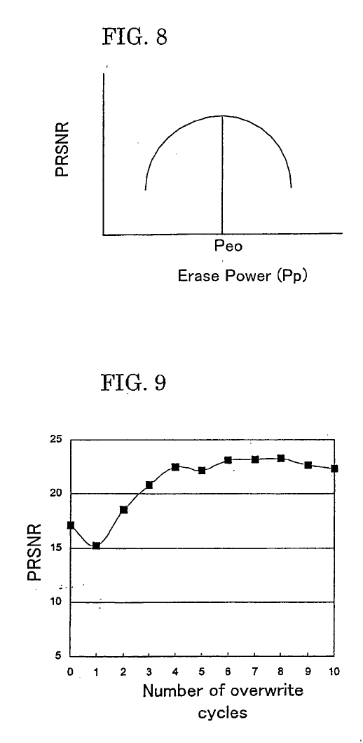

In the next step (Step 445), as shown in FIG. 8 by way of example, the relationship between erase power (Pe) and PRSNR is established using the PRSNR information

In the next step (Step 447), a value for ease power (Pe) which corresponds to a maximum PRSNR value is calculated from the graph of erase power (Pe) vs. PRSNR (see FIG. 8). The obtained erase power value (Peo) is considered an optimum value for erase power (Pe). Note that the maximum PRSNR value is 15 or more.

In the next step (Step 501), the CPU 40 instructs the drive control circuit 26 to focus a beam spot onto the target position. More specifically, the drive control circuit 26 is instructed to form a beam spot near the target position corresponding to the designated address. In this way a seek operation is performed. If the seek operation is not required, this step is skipped.

In the next step (Step 503), recording conditions are set. Here, the recording power is set to Ppo and erase power is set to Peo, that is, optimum values are set for both of the recording power and erase power.

In the next step (Step 505), permission of information recording is given. As a result, user data is recorded in the designated address under optimum recording conditions by means of the encoder 25, the laser control circuit 24, and the optical pickup device 23.

A method for determining optimum laser beam power that follows the foregoing steps will be described in detail. Rewritable optical recording media using phase change material undergo recording characteristic changes after each overwrite cycle. There is no practical problem if the characteristic change is small enough to satisfy the standard values. However, it becomes a problem if the characteristic values decreased to near the standard values after several overwrite cycles and thereby an optimum laser beam power range was narrowed. FIG. 9 shows how PRSNR of the first information layer 2 changes with increasing number of recording cycles from 1 to 11, i.e., overwrite cycles from 1 to 10. It is apparent from FIG. 9 that PRSNR decreased after first overwrite cycle. If the standard value is set to 15 or higher in FIG. 9, the PRSNR value is close to the standard. The adoption of recording power and erase power which are higher or lower than those that succeeded in obtaining the results shown in FIG. 9 fails to satisfy the standard value. If it succeeded in satisfying the standard value, it often results in a narrow optimum laser beam power range, e.g., 0.1 mW. In such a case, it is preferable to set an optimum recording power after first overwrite cycle on the assumption, of course, that no characteristic value reductions are seen in subsequent overwrite cycles. If the characteristic values decreased to a great extent after first overwrite cycle, an optimum erase power range becomes narrow. Accordingly, optimization of erase power is particularly important. Considering this fact, it is preferable to determine an optimum laser beam power based on the characteristic values obtained after first overwrite cycle. When the optimum recording power and optimum erase power after first overwrite cycle showed little or no change, it is preferable to determine an optimum laser beam power based on the characteristic values obtained after 10 overwrite cycles with relatively small variations in characteristic values. The reason for this is that there may be large variations in characteristic values obtained after first overwrite cycle in some optical recording/reproduction apparatus and it may result in failure to obtain proper values for optimization.

In the case of single-side, dual-layer optical recording media, there may be differences in recording sensitivity between the first information layer 2 and the second information layer 4 that is arranged in a position farther to the laser irradiation side than is the first information layer 2. In some of these optical recording media, the recording sensitivity of the second information layer 4 may differ depending on whether the first information layer 2 has been or has not been written. Accordingly, it is important to optimize a laser beam power for each information layer. To achieve this, for the first information layer 2, the dependency of the modulation on the recording power during 10 overwrite cycles is investigated as described above to thereby calculate γtarget, Ptarget, “ε” and “ρ.” Thereafter, an optimum erase power is determined based on the characteristics obtained after first overwrite cycle or overwrite cycles, followed by determination of a final value for “ε” (as ε=ε′).

Moreover, test write is performed on the read-in area—an area closer to the disc center than is the user data area. Next, the second information layer 4 determines an optimum laser beam power and an optimum condition on another test write area that is closer to the outermost periphery of the disc than is the user data area. Prior to this test write, it is preferable to previously write the first information layer 2 on an area corresponding to that test write area in terms of radial position. In this case, however, it takes time for the pickup head to seek for a given test write area. To avoid this, the media maker previously records in the optical recording media a correction factor for correcting an change in optimum recording power for the second information layer 4, which results from writing of the first information layer 2. This enables determination of γtarget, Ptarget, “ρ” and “ε” of the second information layer 4 with the first information layer 2 remains unwritten, to thereby determine an optimum laser beam power.

The values to be stored in the recording media as information for determining an optimum laser beam power are γtarget, Ptarget, “ρ,” “ε” and asymmetry. In the case of single-side, dual-layer optical recording media, these values are recorded in each of their two information layers. Furthermore, recording sensitivity correction factors for the first and second information layers 2 and 4 are recorded. More specifically, these values are recorded in the form of embossed pits formed on a given area called the read-in area. In addition to the characteristic values noted above, error rate may be used.

### EXAMPLES

Hereinafter, the present invention will be described with reference to Examples, which however shall not be construed as limiting the invention thereto. Information was recorded with the write strategy shown in FIG. 1, the recording/reproduction velocity was set to 6.61 m/s, and the reproduction power was set to 0.7 mW. DVD Sprinter (single-wafer sputtering equipment, manufactured by Balzers) was used. Note that “10 recording cycles” means “9 overwrite cycles,” and “2 recording cycles” means “1 overwrite cycle.”

### Example 1

As a first substrate 1, a polycarbonate substrate was prepared which is 12 cm in diameter and 0.595 mm in average thickness and which has a continuous wobble groove (track pitch=0.40 μm) on one side. In an Ar gas atmosphere, a first lower protective layer 2a of 44 nm thickness, a first recording layer 2b of 7.5 nm thickness, a first upper protective layer 2c of 20 nm thickness, a first reflective layer 2d of 10 nm, and a thermal diffusion layer 2e of 25 nm thickness were sequentially deposited onto the polycarbonate substrate by magnetron sputtering of their sputtering targets: ZnS(80 mol %)-SiO₂(20 mol %) for the first lower protective layer 2a, Ag_{0.2}In_{3.5}Sb_{69.8}Te₂₂Ge_{4.5} for the first recording layer 2b, In₂O₃(7.5 mol %)-ZnO(22.5 mol %)-SnO₂(60 mol %)-Ta₂O₅(10 mol %) for the first upper protective layer 2c, Ag for the first reflective layer 2d, and In₂O₃ (90 mol %)-ZnO(10 mol %) for the thermal diffusion layer 2e.

In addition, as a second substrate 5, a polycarbonate substrate was prepared which is 12 cm in diameter and 0.600 mm in average thickness and which has a continuous wobble groove (track pitch=0.40 μm) on one side. In an Ar gas atmosphere, a second reflective layer 4d of 140 nm thickness, a second upper protective layer 4c of 22 nm thickness, a second recording layer 4b of 15 nm thickness, and a second lower protective layer 4a of 65 nm thickness were sequentially deposited on the polycarbonate substrate by magnetron sputtering of their sputtering targets: AgBi (Bi=0.5 wt %) for the second reflective layer 4d, ZnS(80 mol %)-SiO₂(20 mol %) for the second upper protective layer 4c, Ag_{0.2}In_{3.5}Sb_{69.8}Te₂₂Ge_{4.5} for the second recording layer 4b, and ZnS(80 mol %)-SiO₂(20 mol %) for the second lower protective layer 4a.

The surface of the thermal diffusion layer 2e was coated with UV-curable resin (KAYARADDO DVD003M produced by NIPPON KAYAKU CO., LTD.), and bonded to the second lower protective layer 4a. The UV-curable resin was cured by irradiation with UV from the first substrate side to form an intermediate layer 3, thereby obtaining a dual-layer phase change optical disc with two information layers. Note that the thickness of the intermediate layer 3 was set to 25 μm±3 μm as measured from the inner area to outer area of the disc.

With initialization equipment, the second recording layer 4b and first recording layer 2b were sequentially initialized by irradiation with a laser beam from the first substrate side. In this initialization process a laser beam from the semiconductor laser (oscillation wavelength=810±10 nm) was focused by objective lens (NA=0.55) down to a spot on the respective recording layers. The initialization condition for the second recording layer 4b was as follows: disc rotation=CLV (Constant Linear Velocity) mode; linear velocity=3 m/s; pickup head feed rate=36 μm/revolution; radial position (distance from the rotation center)=22-58 mm; and initialization power=350 mW. The initialization condition for the first recording layer 2b was as follows: disc rotation=CLV (Constant Linear Velocity) mode; linear velocity=5 m/s; pickup head feed rate=50 ml/revolution; radial position (distance from the rotation center)=23-58 mm; and initialization power=500 mW. The optical transmittance of the first information layer 2 after initialization was 40.1%.

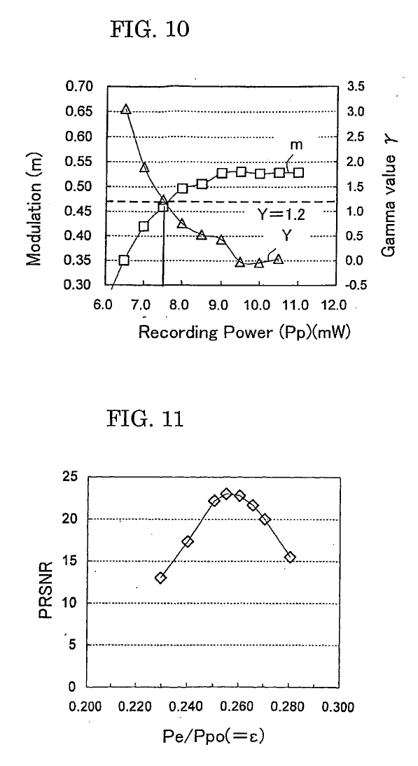

As test write, the first information layer 2 was written 10 times with the following write strategy: Ttop=0.30T, dTtop=0.05T, Tmp=0.25T, and dTera=0.0T. As a result, the recording power (Pp) changed with modulation (m) as shown in the graph of FIG. 10. At this point, the bias power (Pb) was set to 0.1 mW, and “ε” was set to 0.25. In addition, γtarget was set to 1.2. Furthermore, the dependency of PRSNR on recording power was previously investigated using a tester, and it was revealed that recording power providing a maximum PRSNR value was 9.5 mW, and erase power was 2.5 mW at this time.

Then, the value for “ρ” was determined so that the recording power (Ppo) come close to around 9.5 mW. More specifically, determining Ptarget based on the previously selected γtarget value, Ptarget of 7.55 mW was obtained (see FIG. 10). Subsequently, based on Ptarget obtained above, 1.26 was selected as the value for “ρ” so that recording power (Ppo) comes close to 9.5 mW. That is, Ppo was given 9.51 mW (=1.26×7.55).

As shown in FIG. 11, various “ε” (=Pe/Ppo) values were set by changing erase power (Pe) with respect to the fixed recording power (Ppo) (=9.5 mW), calculating PRSNR after 10 recording cycles. The “ε” value that provided a maximum PRSNR value was 0.26. Peo at this point was 2.5 mW, a value nearly the same as that determined on a temporarily basis previously. Thus, “ε” was set to 0.26. Upon determination at the recording apparatus side, the value for erase power may be selected at a point where the rate of PRSNR change levels off. Asymmetry in this recording condition was as small as 0.005, a value which is almost zero.

### Example 2

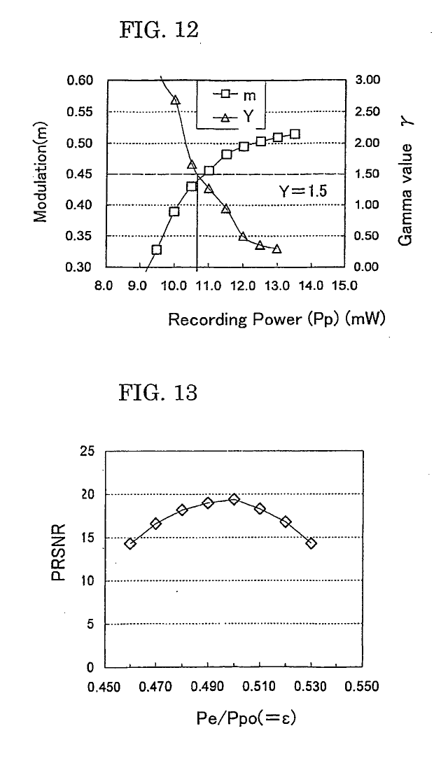

An optimum laser beam power is determined for the second information layer 4 of Example 1 as in Example 1. In this case, parameters relating to the “γ” value, “ρ” value, “ε” value, and write strategy for each of the first and second information layers 2 and 4 are previously stored in the read-in area of the first information layer 2 on the first substrate 1 side. When test write is to be performed on the second information layer 4, either the read-out area of the second information layer 4—the periphery of the second information layer 4—or the read-in area is selected. In this Example, the read-out area was written. Then the “γ” value of 1.5, “ρ” value of 1.20, and “ε” value of 0.5 were read out from the disc, and test write was performed 10 times with the following write strategy: Ttop=0.5T, dTtop=0T, Tmp=0.4T, and dTera=−0.2T (where −0.2T means to apply the last Pb laser beam shown in FIG. 1 for 0.2T longer after the data signal end). As a result, recording power (Pp) showed a dependency on modulation as shown in FIG. 12.

As in Example 1, Ptarget was 10.7 mW and “ρ” was 1.20, and Ppo was 12.84 mW (=1.20×10.7). That is, the optimum recording power (Ppo) was 12.85 mW.

As shown in FIG. 13, various “ε” (=Pe/Ppo) values were then set by changing erase power (Pe) with respect to the fixed optimum recording power (Ppo) (=12.85 mW), calculating PRSNR after 10 recording cycles. The “ε” value that provided a maximum PRSNR value was 0.5. Peo at this point was 6.425 mW.

### Example 3

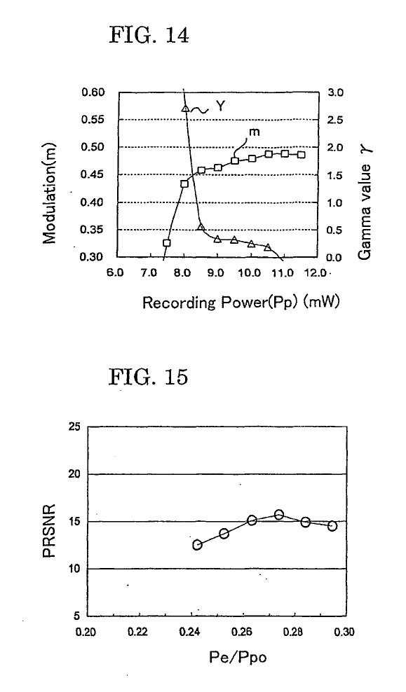

Using an optical recording medium identical to that prepared in Example 1, the relationship between modulation (m) of the first information layer 2 and recording power (Pp) was investigated. The relationship is shown in FIG. 14. The value for “ε” was set to 0.25.

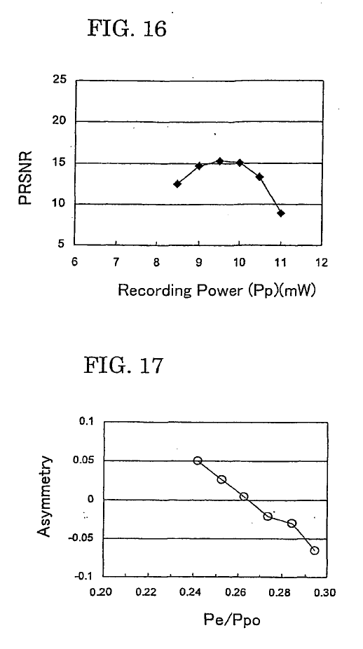

Thus, when setting the γtarget value to 1.3, the Ptarget value is 8.33 mW. The graph of PRSNR vs. recording power shown in FIG. 16 tells that the optimum recording power (Ppo) is 9.5 mW, and therefore, the value for “ρ” was set to 1.14. To be more specific, the optimum recording power (Ppo) obtainable from above equals to (ρ×Ptarget), that is, 9.5 mW.

As shown in FIG. 15, various “ε” (=Pe/Ppo) values were then set by changing erase power (Pe) with respect to the fixed optimum recording power (Ppo) (=9.5 mW), calculating PRSNR after 2 recording cycles. The “ε” value that provided a maximum PRSNR value was 0.275. Peo at this point was 2.52 mW. From the above, “ε” was set to 0.275.

### Example 4

A maximum PRSNR value was obtained at “ε” 0.265. It is effective to additionally adopt asymmetry in a case where it is difficult to measure PRSNR without any variations in the recording/reproduction apparatus or where there are large variations in performance level among recording/reproduction apparatus. FIG. 17 shows the dependency of asymmetry on “ε” (=Pe/Ppo) after 2 recording cycles. The asymmetry value that provides a maximum PRSNR value is 0.004, which is almost zero. When an optimum erase power is to be determined using recording/reproduction apparatus, the designated asymmetry value “β” is used. Accordingly, in addition to the write strategy, “ε,” “γtarget,” “Ptarget” and “ρ,” the asymmetry value “β” is stored as a necessary parameter in the first information layer 2. In this Example “β” was set to 0.00.

### Example 5

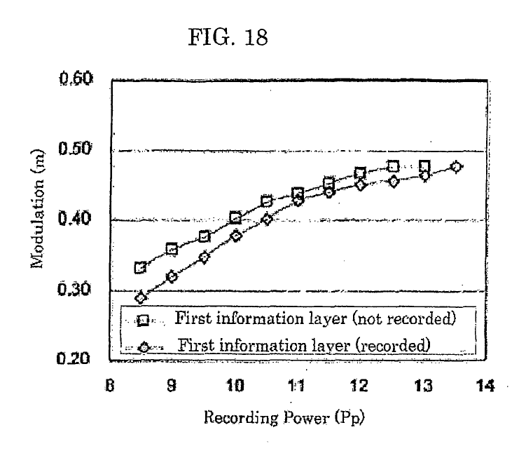

Using an optical recording medium identical to that prepared in Example 1, an optimum recording condition for the first information layer 2 is determined, followed by determination of an optimum laser beam power for the second information layer 4. In this Example, the first information layer 2 is previously written with a laser beam of an optimum recording power, and the second information layer 4 is written at a position corresponding to the recorded area of the first information layer 2. FIG. 18 shows the dependency of the modulation of the second information layer 4 on the recording power in this recording process.

A sample disc overwritten 10 times and has a written first information layer was compared to a sample disc overwritten 10 times but has no written first information layer. There was about 0.5 mW difference in recording sensitivity between them; one that is provided with a written first information layer 2 showed poor recording sensitivity. In this case, a recording sensitivity correction factor is added as a new parameter so as to compensate such a difference without having to write the first information layer 2. Here, the correction factor is 1.04 as the recording sensitivity ratio is 13.5/13.0 (=1.04). As another candidate for the above-noted correction factor, either the recording power ratio or the difference in obtained recording power may be adopted. If it is assumed that the sensitivity difference is 1.0 mW, the optimum recording power (Ppo) is found by the equation: Ppo (expected minimum power with L0 recording)=Ppo (without L0 recording)+1.0 mW.

### Example 6

An optical recording medium identical to that prepared in Example 1 was written 10 times at optimum recording powers obtained in Examples 1 and 2, and the reflection signal voltage for the mark space between the longest marks was measured for each of the first and second information layers 2 and 4. Subsequently, with sputtering equipment, a Ag film was deposited onto a glass substrate to a thickness of 200 nm to fabricate a disc. With a media evaluation device, a laser beam was focused on the disc at a reproduction power of 0.7 mW to measure reflection voltage. This reflection voltage was considered 75% reflectance, and the reflectance (R) of each information layer was calculated using the following equation:

R=75×(Reflection Voltage for Each Information Layer)/(Reflectance of Ag Film)

The reflectance (R1) of the first information layer and the reflectance of the second information layer (R2) were 4.0% and 3.2%, respectively.

### INDUSTRIAL APPLICABILITY

As described above, the method of the present invention for determining an optimum laser beam power is suitable for the determination of a proper laser beam power upon recording on an optical disc having multiple rewritable recording layers. The optical recording medium of the present invention is suitable for stable, high-quality recording. The program for executing the method of the present invention and the recording medium storing the program are suitable for causing an optical disc device to perform stable, high-quality recording on an optical recording disc having multiple rewritable recording layers. The single-side, dual-layer optical disc of the present invention is a suitable disc on which the method of the present invention is to be performed. It is also possible to determine an optimum laser beam power even for a disc with a single information layer by using the method of the present invention.

1. A method for determining an optimum laser beam power for a single-side, dual-layer optical recording medium having first and second information layers, the method comprising:
determining an optimum laser beam power based on a predetermined characteristic value at a time when a number of overwrite cycles on the recording medium is a predetermined value,
wherein the method is conducted by an optical recording/reproduction apparatus utilizing optical change, and
wherein the first information layer is closer to the laser irradiation side than the second information layer.

2. The method for determining an optimum laser beam power according to claim 1, wherein a recording power is optimized based on a modulation of the longest mark among marks of various lengths, and an erase power is optimized based on PRSNR while using the optimized recording power as a fixed value.

3. The method for determining an optimum laser beam power according to claim 1, wherein the number of overwrite cycles on the recording medium is 1.

4. The method for determining an optimum laser beam power according to claim 1, wherein the number of overwrite cycles on the recording medium is 10, which is a value where characteristic values are stabilized.

5. The method for determining an optimum laser beam power according to claim 2, wherein the optimum erase power is determined at a point where PRSNR is maximized or a rate of PRSNR change with erase power levels off.

6. The method for determining an optimum laser beam power according to claim 2, wherein the optimum erase power is determined so that asymmetry has a predetermined value.

7. The method for determining an optimum laser beam power according to claim 1, wherein an optimum laser beam power is determined for the second information layer in a state where the first information layer is recorded after an optimum laser beam power has been determined for the first information layer.

8. An optical recording medium comprising:
information that is necessary to execute a method for determining an optimum laser beam power, the method comprising:
determining an optimum laser beam power based on a predetermined characteristic value at a time when a number of overwrite cycles on the recording medium is a predetermined value,
wherein the method is conducted by an optical recording/reproduction apparatus utilizing optical change, and
wherein the recording medium includes first and second information layers, the first information layer being closer to the laser irradiation side than the second information layer.

9. An optical recording medium comprising:
a recording sensitivity correction factor that allows a method for determining an optimum laser beam power to determine an optimum laser beam power for a second information layer without writing a first information layer, the method comprising:
determining an optimum laser beam power based on a predetermined characteristic value at a time when a number of overwrite cycles on the recording medium is a predetermined value,
wherein the method is conducted by an optical recording/reproduction apparatus utilizing optical change, and
wherein the first information layer is closer to the laser irradiation side than the second information layer.

10. The optical recording medium according to claim 8, wherein the reflectance of each of the first and second information layers at positions corresponding to a user data area is 3% to 6%.
